(19) United States
(12) Patent Application Publication
(10) Pub. No.: US 2008/0096008 A1
(43) Pub. Date: Apr. 24, 2008

(54) Electrophotographic Transfer Paper

(76) Inventors: Jiro Yoshimura, Tokyo (JP); Hisahiro Omote, Tokyo (JP); Masahito Suzuki, Tokyo (JP); Koji Okomori, Tokyo (JP); Dai Nagahara, Tokyo (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/576,430

(22) PCT Filed: Sep. 29, 2005
(86) PCT No.: PCT/JP05/17966

§ 371 Date: Aug. 8, 2007

(30) Foreign Application Priority Data
Sep. 30, 2004 (JP) 2004-289221
Aug. 4, 2005 (JP) 2005-227079

(51) Int. Cl. G03G 7/00; B32B 5/16

(52) U.S. Cl. 428/326

(57) ABSTRACT

The present invention is an electrophotographic transfer paper having a coating layer containing a pigment and a binder on at least one side of a base paper comprising a pulp and a filler, and excellent transport characteristics in high-speed copy machines and printers. 30 wt % or more of the pigment is kaolin having a particle size distribution wherein 65% or more particles are in a range of 0.4-4.2 μm based on volume, and/or delaminated clay having an average particle size of 3.5-20 μm. The clark stiffness in the CD direction of the electrophotographic transfer paper is 20 cm³/100 or more.

### FIELD OF THE INVENTION

The present invention relates to an electrophotographic transfer paper, and in particular to an electrophotographic cut paper which satisfies the requirements of continuous transport properties in high-speed electrophotographic copy machine and printers (hereafter, “high-speed copy machine etc.”), which has excellent color printing performance and is suitable for use as a document paper.

### BACKGROUND OF THE INVENTION

In the prior art, paper used in high-speed electrophotographic machinery was continuous paper supplied by continuous sheet feeding or winding. However, in recent years, in the field of electrophotographic copy machine or printers using small size cut paper, machines have been realized which have a transport rate of 135-180 sheets per minute. When small size cut paper (hereafter, sheet paper) is used, there is the advantage that the paper size and type can easily be changed, there is no need to cut the paper for bookbinding, and cutting debris is not produced.

Electrophotographic copy machine and printers are suitable for printing small lots of several thousand copies or less, such as so-called on demand printing of manuals and self-published work. Therefore, it is preferable to use sheet paper since it can comply closely with customer requirements. However, copy machines and printers using sheet paper have a disadvantage, that it is difficult to attain high speed, compared to copy machines and printers which use the continuous papers.

In the case of copy machines and printers using sheet paper, paper transport is not accomplished by gripping the paper between grips, although this transportation method is carried out in an offset printing press, but instead, the paper is gripped between rolls or a belt, and if paper with low transport properties (mainly, paper with low stiffness) was used, it is not easily transferred between rolls, therefore, the paper becomes jammed and continuous printing is difficult.

In the prior art, woodfree paper was used which was compatible with high-speed electrophotographic copy machines and printers which use sheet paper. However, with increasing demand for self-published work and the like, a demand has emerged for a coating type of paper which can meet diverse customer needs, and has excellent printing qualities which permits continuous printing in high-speed copy machines etc. When paper is used as text paper for books, its weight (areal weight) and thickness are important. One sheet of paper may be light, but the weight becomes significant when plural sheets are brought together in a book. Since books using coated paper for text are extremely heavy, light and thin paper is therefore desired.

In the prior art, as regards electrophotographic paper having a coating layer of pigment on the base paper surface, a paper having a coating layer containing a pigment with a specific particle size and a binder is disclosed, which was subjected to smoothing treatment, and has a specific center line average roughness, a specific surface electrical resistance or a specific inter-sheet frictional resistance coefficient (Patent documents 1-3). However, these papers for electrophotography use were not satisfactory from the viewpoint of image quality reproducibility and paper transport properties. It has also been disclosed that image compatibility and paper transport properties can be improved by specifying the areal weight, surface roughness of the coating layer and stiffness (Patent document 4), but the quality in full color is still inadequate, and high-speed paper transport cannot be obtained.
Patent document 1: JP-A S62-198875
Patent document 2: JP-A S62-198876
Patent document 3: JP-A S62-198877
Patent document 4: JP-A 2000-172001

Hence, in the prior art, it was difficult to obtain a coated electrophotographic transfer paper suitable for obtaining high quality full-color images with a high-speed copy machines etc.

### SUMMARY OF THE INVENTION

### Problems Which This Invention Aims To Solve

It is therefore an object of the present invention to provide an electrophotographic transfer paper with a low areal weight, which has excellent full-color image reproducibility, and excellent transfer properties in a high-speed copy machines etc.

As a result of intensive efforts, the inventors discovered an electrophotographic transfer paper having a coated layer of a pigment and a binder on a base paper surface, wherein, by using kaolin of specific particle size distribution and/or delaminated clay of specific average particle size for the coating layer, color printing properties are excellent, paper transport in high-speed electrophotographic copy machines and printers is improved, and in particular, paper transport properties of small cut paper is improved.

It was further discovered that if precipitated calcium carbonate/silica complex was contained as a filler in the base paper, the rigidity of the electrophotographic transfer paper improved, paper transport properties improved even at a low areal weight, and image density improved.

### Means for Solving the Problems

The present invention is an electrophotographic transfer paper having a coating layer containing a pigment and a binder on at least one side of a base paper comprised of a pulp and a filler, wherein the pigment contains kaolin of which 65% or more has a particle size distribution of 0.4-4.2 μm based on volume, and/or 30 wt % or more of delaminated clay having an average particle size of 3.5-20 μm, and the Clark stiffness in the CD direction of the electrophotographic transfer paper is 20 cm³/100 or more.

In the present invention, it is preferred that the base paper contains a filler comprising a precipitated calcium carbonate/silica complex wherein the surface of precipitated calcium carbonate particles is coated with silica, and the solid weight ratio of precipitated calcium carbonate and silica (precipitated calcium carbonate/silica) in this precipitated calcium carbonate/silica complex is 30/70-70/30. It is further preferred that, when a voltage of −10 kV is applied at 23° C., 50% RH, the time required for the maximum value of the charge voltage to decay to ½ is 0.25 seconds or less.

### ADVANTAGES OF THE INVENTION

The electrographic transfer paper of the present invention has excellent color printing suitability, image density and gloss in the printed part. Moreover, continuous paper transport properties for high-speed electrophotographic copy machines etc. is satisfactory, and in particular, the transport properties of low areal weight small cut paper is good. Hence, the paper is convenient for use in self-published works, and as paper for books.

### BRIEF DESCRIPTION OF THE DRAWINGS

FIG. 1 is a schematic diagram of a hanging curl measurement.

### DESCRIPTION OF THE PREFERRED EMBODIMENTS

The base paper used by the present invention mainly consists of pulp and a filler. The pulp used may be for example at least one selected from among a chemical pulp such as LBKP (broadleaf bleached kraft pulp), NBKP (needleleaf bleached kraft pulp), LBSP (broadleaf bleached sulfite pulp), NBSP (needleleaf bleached sulfite pulp), a mechanical pulp such as stone groundwood pulp (SGP), pressurized stone groundwood pulp (PGP), refiner groundwood pulp (RGP), chemigroundwood pulp (CGP), thermogroundwood pulp (TGP), groundwood pulp (GP), thermomechanical pulp (TMP), chemthermomechanical pulp (CTMP), refiner mechanical pulp (RMP), and a recycled pulp such as deink pulp (DIP). These pulps may be blended as required in any desired ratio. In the invention, in order to obtain satisfactory full-color compatibility and improve whiteness, the total pulp preferably contains 70 wt % or more, and more preferably 80 wt % or more, of a chemical pulp. Moreover, in order to increase gas permeability, it preferably contains 10% or more of mechanical pulp per unit weight of pulp. However, from the viewpoint of whiteness, it preferably contains 60 wt % or less, and more preferably 40 wt % or less, of a mechanical pulp. Among mechanical pulps, the use of groundwood pulp which contributes to low density, is preferred.

The filler used in the base paper may be for example an inorganic filler such as heavy calcium carbonate, talc, magnesium carbonate, barium carbonate, aluminum hydroxide, calcium hydroxide, magnesium hydroxide, zinc hydroxide, clay, calcinated kaolin, delaminated kaolin, amorphous silicate, titanium dioxide, zinc oxide, silicon oxide, or amorphous silica, urea-formalin resin, polystyrene resin, phenol resin, or minute hollow particles. The amorphous silicate may be an insoluble silicate, specific examples thereof being hydrated aluminum silicate, hydrated sodium aluminum silicate, hydrated calcium silicate and hydrated magnesium silicate. One, two or more of these fillers may be used. From the viewpoint of improving image quality and paper transport properties, it is preferable to contain 2-10 weight % of the amorphous silicate as a filler in the paper. The amount of the total filler in the paper is preferably 1-30 wt %, more preferably 3-25 wt % and still more preferably 5-25 wt %. If it exceeds 30 wt %, the rigidity of the base paper declines, and not only paper transport properties in a copy machines but also ease of handling decline.

In the present invention, in addition to the aforesaid fillers, the use of precipitated calcium carbonate/silica complex as a filler is particularly preferred. If precipitated calcium carbonate/silica complex is used, Clark stiffness can be increased without increasing the areal weight. In the present invention, “precipitated calcium carbonate/silica complex” means that the surface of the precipitated calcium carbonate particles are coated with silica, and the substance has a low density (bulk), and excellent whiteness and opaqueness. Since the rigidity of the base paper which contains this precipitated calcium carbonate/silica complex as a filler is high, the paper has excellent paper transport properties and handling properties in the copy machines and laser beam printers.

The precipitated calcium carbonate/silica complex may be used alone or in conjunction with the aforesaid fillers, but the blending proportion of the precipitated calcium carbonate/silica complex in the paper is preferably 1-25 wt %, and more preferably 3-25 wt %. The most preferred content is 5 to 20 wt %. If the amount of filler in the paper is less than 1 wt %, bulk and opaqueness are not sufficient. Moreover, if the filler in the paper exceeds 25 wt %, rigidity and strength fall, and paper transport properties are poorer.

The precipitated calcium carbonate/silica complex used in the present invention may be manufactured by reacting silicic acid in a process which produces calcium carbonate, or by reacting silicic acid on the surface of the obtained calcium carbonate. In the present invention, the method of reacting silicic acid on the surface of the calcium carbonate is preferred from the viewpoint of obtaining a good product balance between bulk, opaqueness and rigidity. This process is described below.

First, precipitated calcium carbonate is dispersed in water. The crystals of precipitated calcium carbonate may be calcite or aragonite, and the crystal morphology may be acicular, columnar, spindle-shaped, globular, cubic, non-defined or rosetta. In particular, rosetta type precipitated calcium carbonate has a shape where the spindle-shaped precipitated calcium carbonate primary particles are echinulate, and since the specific surface area and oil absorption are higher than those of other forms of calcium carbonate, it is preferred. When the precipitated calcium carbonate/silica complex prepared using this rosetta type precipitated calcium carbonate is used as a filler, bulk, opacity and stiffness of the electrophotographic transfer paper obtained are better than when the precipitated calcium carbonate/silica complex used as a filler is prepared using another precipitated calcium carbonate, and paper transport properties are improved. Also, the precipitated calcium carbonate can be used after performing a crushing treatment.

The concentration of the reaction solution of this precipitated calcium carbonate is preferably 1-20 wt %. Since the blending ratio of precipitated calcium carbonate and silicic acid is important, this concentration is determined taking account of also the effect of the silicic acid concentration. In the case of a low concentration of 1 wt % or less, the production amount per batch is less and productivity is poor. If it exceeds 20 wt %, dispersibility is poor, and since the usage amount of silicic acid used for the reaction is increased in proportion to the usage amount of precipitated calcium carbonate, viscosity during the reaction increases and the operation becomes more difficult.

Next, silicic acid dissolved in an aqueous alkali solution such as that of sodium or potassium is added to a slurry of this precipitated calcium carbonate. Industrially, sodium silicate or potassium silicate is generally used. When forming the complex used in the present invention, the ratio of silicic acid and alkali may be any desired ratio, but in the case of No. 3 silicic acid, the molar ratio of SiO₂:Na₂O is about (3-3.4):1, therefore, this is easily obtained. The weight ratio when the precipitated calcium carbonate and silicic acid alkali are introduced, is arranged to be such that the weight ratio of calcium carbonate and silica in the obtained precipitated calcium carbonate/silica complex is within a target range. In the present invention, the solid content weight ratio (CaCO₃/SiO₂) of the calcium carbonate and silica in the precipitated calcium carbonate/silica complex, is preferably 30/70-70/30.

The obtained slurry is thoroughly dispersed by stirring, e.g., with an agitator, homomixer or mixer. In this case, the precipitated calcium carbonate should be thoroughly dispersed in water so that the particles of precipitated calcium carbonate do not excessively aggregate, wherein the dispersion time and strength of agitation are not particularly limited.

Next, a neutralization reaction is performed using a mineral acid. The mineral acid to be used can be suitably selected from those known in the art. The mineral acid may contain a metal acid salt such as aluminium sulfate or magnesium sulfate. From the viewpoint of industrial mass production, an acid obtained economically, such as sulfuric acid or hydrochloric acid, is preferably used.

If a highly concentrated acid is used for neutralization, and stirring is incomplete, areas occur where the pH is low due to the addition of acid and the precipitated calcium carbonate decomposes, so to prevent this decomposition, vigorous stirring must be performed at the acid addition inlet using a homomixer or the like. On the other hand, if the acid used for neutralization is too dilute, the total volume increases to a large extent due to the addition of acid, which is undesirable. As for the concentration of the acid used at the time of neutralization, it is preferred that it is more than 0.05N.

The addition of the mineral acid and aqueous solution of the acid metal salt which are added if required, is performed at a temperature below the boiling point of the alkaline mixture of the aqueous solution of silicic acid metal salt and precipitated calcium carbonate. If the silicic acid is made to deposit by this neutralization process, amorphous deposited silicic acid will cover the surface of the precipitated calcium carbonate particles.

The aforesaid acid may be added in several steps. Also, maturing may be performed after addition of acid. Maturing means temporarily stopping addition of acid, while continuing to stir or leaving to stand. During maturing, the slurry may be stirred vigorously, or the condensed precipitated calcium carbonate may be ground in order to control the particle shape.

During neutralization of the aforesaid slurry, by making the final pH of the slurry 7-9, the silicic acid deposits and covers the surface of the precipitated calcium carbonate. If the slurry is on the acid side (less than pH 7), the precipitated calcium carbonate will decompose. On the other hand, if the pH is on the alkaline side exceeding 9.0, the silicic acid does not deposit completely, and as some unreacted silicic acid remains in the slurry, the waste of silica increases, which is undesirable.

The precipitated calcium carbonate/silica complex manufactured in this way is a suspension of precipitated calcium carbonate particles whereof the surface is covered by silica. Although this suspension may be used for a papermaking process, etc., as it is, there is a possibility that salts of by-products remaining in solution may change to poorly soluble metal salts such as calcium sulfate in the papermaking process, and may cause scaling. Therefore, it is preferred to separate the solid and liquid by performing a filtration or centrifugal separation to remove salts of by-products generated by neutralization as far as possible. Further, the precipitated calcium carbonate/silica complex can be obtained also by re-dispersing the cake-like complex whose concentration of solid content after this solid liquid separation is 10 to 50 wt %, and repeating a solid-liquid separation using water or ethanol.

In order to remove larger, coarser material than the target particle size from the obtained precipitated calcium carbonate/silica complex, a vibration screen and a screen are used and particles of 100 μm or more are removed. The average particle size of the precipitated calcium carbonate/silica complex can be adjusted, as described above, also by vigorously stirring and crushing during maturing of the slurry to control the particle shape, but the solid after completion of the neutralization reaction or the solid obtained after solid-liquid separation can be adjusted to obtain the target average particle size using a wet crusher. The average particle size may also be adjusted by combining these methods.

The average particle size of the precipitated calcium carbonate/silica complex used in the present invention, is preferably 20 μm or less, but particularly preferably 1-10 μm.

In the present invention, an internal sizing agent other than a pulp and filler can be used. Examples of the internal sizing agent are a rosin sizing agent, synthetic sizing agent, petroleum resin sizing agent and neutral sizing agent. From the viewpoint of maintaining paper transport properties in electrophotographic copy machines and printers, and storage properties after copying, the use of neutral sizing agents, in particular an alkyl ketene dimer or alkenyl anhydrous succinic acid sizing agent, is preferred. In the present invention, these internal sizing agents are preferably used in conjunction with a fiber fixing agent such as aluminum sulfate, cationic starch or the like. In the present invention, there may also be added a papermaking internal additive such as a paper reinforcing agent, dye, pH control agent, antifoaming agent, and pitch control agent according to the purpose.

When manufacturing the base paper used for the present invention, papermaking can be performed using well known devices, such as a Fourdrinier machine, an on-top twin wire paper machine, and a gap former. As papermaking conditions, adjustment of the pulp beating degree, jet-wire ratio, profile, press and calender is performed.

In papermaking, the surface of the manufactured paper may be coated with various surface sizing agents such as starch, polyvinyl alcohol, latex, anhydrous maleic acid size, olefinic size and styrene-acrylic acid size, dimensional stabilizing agents such as ethylene-urea resin, inorganic charge conducting agents such as sodium chloride, potassium chloride and sodium sulfate, and organic charge conducting agents such as dimethylaminoethyl methacrylate, and surfactants. The method used in the size press process may be a conventional size press (two roll, pond method), gate roll size press, rod metaling size press, metaling blade mode size press, bill blade, short dwell coater or the like.

When using precipitated calcium carbonate/silica complex as a filler, it is preferred that the papermaking pH is 6-9 for neutral paper making. This is because, if papermaking is carried out in an acid environment, the precipitated calcium carbonate in the complex particles will decompose or dissolve due to the acid in the papermaking slurry. Further, in alkaline paper making in which the pH exceeds 9, the whiteness of the base paper falls, which is not preferred.

Drying is performed by adjusting the vapor pressure and the aeration method in the dryer of the machine.

Also for low areal weight, since the coated electrophotographic transfer paper of this invention is satisfactory in respect of color image quality and paper transport properties, it can be used in a range where the areal weight of the base paper is 30 g/m²-200 g/m². When used as this paper, the areal weight is preferably 40-100 g/m², and more preferably 50-85 g/m². Further, it is most preferably 50-75 g/cm².

The electrophotographic transfer paper is obtained by providing a coating layer containing a pigment containing kaolin having a particle distribution wherein particles distributed within a range of 0.4-4.2 μm account for 65% or more based on volume measured by laser diffraction, and/or 30 wt % or more of delaminated clay having a particle distribution within a range of 3.5-20 μm based on volume measured by laser diffraction, and a binder, on at least one side of the aforesaid base paper.

If a pigment with a high particle size uniformity is used, it is difficult to obtain a maximum filling packing structure compared with the case where a pigment of low uniformity is used, so a coating layer of high bulk containing a relative large number of voids is formed. The Clark stiffness of the coated paper thereby increases, and a transfer paper having excellent paper transport properties can be obtained. Moreover, since the base paper coating properties are improved, a smoothing treatment can be given under lower pressure conditions than in the ordinary calender treatment. Due to this, a coating layer having good coating properties is uniformly formed on the paper surface, charge irregularities do not easily occur, toner transfer properties and fixing properties are excellent, and the image density and gloss of the printed part are enhanced.

In the present invention, by including kaolin having a particle size distribution wherein 65% or more of the particles are distributed in a range of 0.4-4.2 μm, and delaminated clay whereof the average particle size is 3.5-20 μm in the pigment, not only are excellent paper transport properties, toner transfer properties and fixing properties obtained, but image density and gloss are also enhanced.

If kaolin is used having a particle size distribution wherein less than 65% of particles lie within a range of 0.4-4.2 μm, the obtained transfer paper print density, gloss after printing and paper transport properties decrease.

Further, if delaminated clay is used whereof the average particle size is less than 3.5 μm, the obtained transfer paper tends to have poorer print density and image gloss, whereas if the average particle size exceeds 20 μm, coating imperfections such as streaks, scratches and bleeding occur.

The delaminated clay used in the present invention is obtained by peeling ordinary clay wherein hexagonal sheet clay is laminated into single layers (delamination). In this delaminated clay, relatively large particles are commonly distributed, so large particle sheet-like clay is easily oriented in the coating layer surface, and even if the base paper is coated with a relatively low coating amount, base paper coating properties are good. Therefore, since a smoothing treatment can be given under lower pressure conditions than in the usual calender treatment, a coated paper of low density with good base paper coating properties is obtained.

The kaolin and delaminated clay may both be used alone or in combination with each other. The usage amount of kaolin and/or delaminated clay must be 30 weight parts or more, more preferably 50 weight parts or more and most preferably 60 weight parts or more per 100 weight parts of the pigment in the coating layer, Particle size in this invention means the particle size measured on a volume basis using a laser diffraction method.

In addition to kaolin and/or delaminated clay, one, two or more conventional pigments may also be used, i.e., inorganic pigments such as kaolin having a different particle size range, delaminated clay having a different average particle size, clay, ground calcium carbonate, precipitated calcium carbonate, talc, titanium dioxide, barium sulfate, calcium sulfate, zinc oxide, silicic acid, silicate, colloidal silica and satin white, and organic pigments such as plastic pigment or the like.

The binder used for the pigment coating layer in the transfer paper of the invention may be one or more moieties suitably selected from among coated paper binders known in the art, i.e., a copolymer such as a styrene-butadiene type, styrene-acrylic type, ethylene-vinyl acetate type, butadiene-methyl methacrylate type or vinyl acetate-butyl acrylate type, a synthetic binder such as polyvinyl alcohol, maleic anhydride copolymer or acrylic acid-methylmeth acrylate copolymer, a protein such as casein, soy protein or synthetic protein, a starch such as oxidized starch, cationic starch, urea phosphorylated starch, etherated starch such as hydroxyethyletherified starch or dextrin, and a cellulose derivative such as carboxyethyl cellulose, hydroxyethyl cellulose or hydroxymethyl cellulose. These binders are preferably used in a proportion of 5-50 weight parts, but particularly 5-25 weight parts, per 100 weight parts of pigment. Various agents for ordinary coated paper may also be blended with the coating composition such as a dispersing agent, a thickener, a water retention agent, an antifoaming agent, a water resistant additive, a colorant, and a printability enhancer, if required.

In the present invention, by arranging the electrical property of the electrophotographic paper such that the time required for the charging voltage to fall to ½ when a voltage of −10 kV is applied at 23°; 50% RH, is 0.25 seconds or less, and more preferably 0.20 seconds or less, suitable electrostatic properties are obtained. Hence, by selecting suitable charging properties in this way, paper transport properties and image quality are enhanced.

In the present invention, to adjust the aforesaid charging property, the charge conducting agent is preferably used in a proportion of 0.1-1.0 parts per 100 weight part of pigment. Examples of the charge conducting agent are an inorganic salt such as sodium chloride, potassium chloride, calcium chloride, magnesium chloride, sodium carbonate, sodium bicarbonate or sodium sulfate, an organic acid salt such as potassium formate or sodium oxalate, a surfactant such as a soap, phosphate or carboxylate, and a polymer electrolyte such as a quarternary ammonium salt, polyacrylate or styrene maleic acid. It is preferred to use an inorganic salt such as sodium chloride, sodium carbonate or sodium bicarbonate.

In manufacturing the transfer paper of the present invention, a coating solution wherein a pigment having a specific particle size distribution, a binder and, if required, an assisting agent and charge conducting agent are blended, is coated on at least one side surface of a base paper. From the viewpoint of image quality and coatability, the solids concentration in the coating liquid of the invention is preferably 45-70 wt %. The pigment coating layer can be provided by coating the prepared coating solution on the base paper by a coater known in the art, i.e., such as a two roll size press coater, gate roll coater and blade metaling size press coater, rod metaling size press coater, film transfer roll coater such as a shim sizer, Fradette nip/blade coater, jet fountain/blade coater and short dwell time applicate coater, a rod metaling coater using a grooved rod or plain rod instead of a blade, a curtain coater or a die coater. The pigment coating layer on the base paper may be provided on one or both sides of the base paper, either in a single layer or two or more layers. From the viewpoint of print suitability and paper transport properties, the coating amount of the invention is preferably 2-15 g/m², and particularly 5-9 g/m² per side.

The drying of the coating layer may be performed by using various driers such as a heating hot blast air dryer, heating cylinder, gas heater dryer, electric heater dryer and infrared heater dryer, either alone or in combination. In the present invention, since the drying state affects the degree of paper curl, it is preferred to use a device which can control the drying balance of two sides of the paper.

The coated paper obtained in this way can also be given increased smoothness by performing a calender treatment. Calender treatment is normally performed by a super calender, gloss calendar or soft calender, etc. which are normally used for smoothing treatment of a coated paper, but in the present invention, since the base paper coating properties are good, a smoothing treatment can be given under lower pressure conditions than those of an ordinary calender treatment. In order to obtain a good balance between image quality and paper transport properties, soft calender treatment is preferred. To prevent loss of Clark stiffness of the transfer paper, and enhance paper transport properties and image quality, the metal roll treatment temperature in calender treatment is preferably 100° ° or more, but particularly 150-250° ° or more. Also, the calender line pressure is preferably 10-200 kg/cm, and more preferably 10-100 kg/cm.

In the electrophotographic transfer paper of the present invention, by arranging the electrical property of the electrophotographic paper such that the time required for the charging voltage to fall to ½ when a voltage of −10 kV is applied at 23°; 50% RH, is 0.25 seconds or less, and more preferably 0.20 seconds or less, good image quality and paper transport properties are obtained, if the decay time becomes long, two or more transfer papers will be sent simultaneously during paper feed due to the residual electrostatic charge, and double feed easily occurs. Further, since the electrostatic charge transferred to the transfer paper surface from the photosensitive drum increases, transfer paper tends to stick to the photosensitive drum, and image defects due to partial scatter of toner tend to occur. The aforesaid decay time may be adjusted by adding a charge conducting agent to the coating layer or using a pigment having charge conducting properties as described above. These methods may be used either alone or in combination.

When printing on small cut paper such as A4 size, from the viewpoint of improving transfer properties in a high-speed copy machine etc. for low areal weight, the Clark stiffness in the CD direction of the electrophotographic paper of the present invention must be 20-80 cm^{3/}100, preferably within the range of 30-80 cm³/100, and more preferably 35-60 cm³/100.

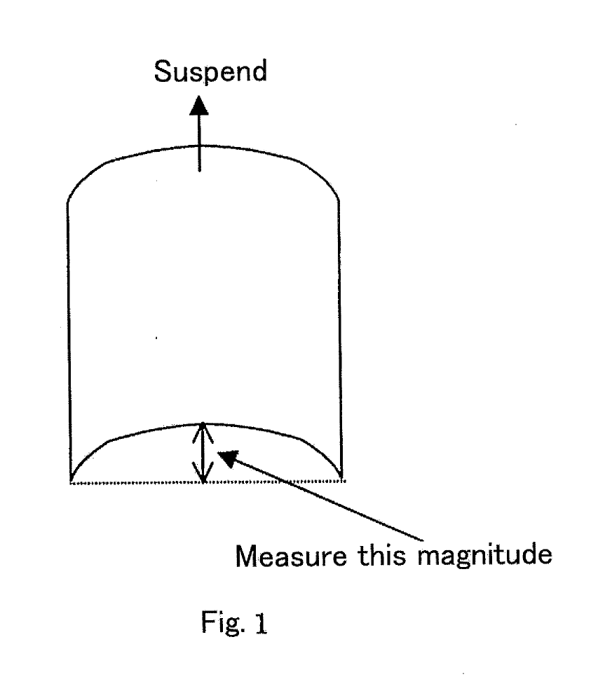

Moreover, in the electrophotographic transfer paper of the present invention, when the hanging curl of A4 size paper is measured in the state shown in FIG. 1, paper transport properties are improved by making the magnitude of the curl with MD (longitudinal direction of A4 paper) 5 mm or less, and making the magnitude of the curl with CD (short direction of A4 paper) 20 mm or less. This curl can be adjusted by adjusting for example papermaking conditions, drying conditions and calender treatment conditions.

Hereafter, the invention will be described in more detail referring to specific examples, but is to be understood that the invention is not to be construed as being limited in anyway thereby. The used pigment particle size was measured, and experiments were performed to determine the properties of the coated paper attained in the examples and comparative examples based on the following criteria.

### EXAMPLES

### (1) Measurement of Pigment Particle Size

A test pigment slurry was prepared by adding 0.2 wt % of sodium hexamethaphosphate as dispersant to pure water, a uniform dispersion was obtained by dripping and mixing, and the particle size of the pigment was measured using a Laser Diffraction particle size distribution measuring instrument (MALVERN Instrument Co.). From this measurement, the percentage of pigment within a range of 0.4 μm-4.2 um was computed, and the 50% point of the volume distribution total amount was taken as the average particle size.

### (2) Areal Weight

Measured according to JIS P 8124.

### (3) Clark Stiffness

Measured according to JIS P 8143.

### (4) Continuous Paper Transport Properties

Printing was performed using a DocuTech 135 made by Fuji Xerox at a paper transport speed of 135 sheets/min (A4 horizontal feed). The paper was cut vertically to A4 size. Continuous transport properties were evaluated by the number of paper jams and double feeds when 10,000 sheets were continuously transported and printed on both sides. The image was a printed area filled with 10 point characters.

### (5) Measurement of Color-Image (Print) Density

Printing was performed using a DocuPrintC 3530 made by Fuji Xerox under the following conditions. Fill images were printed in black, cyanogen, magenta, and yellow.
Print conditions Color mode:—color (automatic selection)
Print mode:—standard
Image quality adjustment mode: recommended
Recommended image type: photograph
Automatic image correction: no
The printed part was measured using a Macbeth densimeter RD-191 made by Gretag Co.

### (6) Image (Print) Gloss

The 75° gloss was measured using a gloss meter GM26D made by Murakami Color Co., ltd.

### (7) Curl

An A4 paper was hung as shown in FIG. 1, the distance shown in the figure was measured, and this distance was taken as the curl.

### (8) Electrostatic Potential Reduction Time

After applying a voltage of −10 kV to a sample surface for 30 seconds at 23° . . . 50% RH using a STATIC HONESTMETER, (TYPE H-0110) made by Shishido Co., the time taken for the electrostatic potential to decline to ½ was measured.

### Example 1

### 1. Manufacture of Base Paper

A pulp slurry for a base paper comprising 30 wt % of needleleaf bleached kraft pulp (NBKP), 40 wt % of broadleaf bleached kraft pulp (LBKP), 4 wt % of hydrated sodium aluminum silicate and 6 wt % of talc per paperweight as filler, 0.2 wt % of a rosin sizing agent as internal sizing agent, and 1.0 wt % of aluminum sulfate as fixing agent, was prepared. Using the obtained pulp slurry, a base paper with an areal weight of 58 g/m² was obtained by manufacturing with a twin wire papermaking machine.

### 2. Preparation of Coating Solution

0.2 weight parts of sodium polyacrylate per 100 wt parts of pigment was added as dispersant to 70 weight parts of kaolin (Capim DG: Imerys Co., volume distribution particle size 0.4-4.2 μm: 68.4%) and 30 weight parts of coarse ground calcium carbonate (FMT-75: Fimatech Co., proportion of particle size 0.4-4.2 μm based on volume: 69.5%) as pigment, water was added and the mixture dispersed by a Sellier mixer to obtain a pigment slurry having a solids concentration of 70 wt %. 10 weight parts of a non-thickening styrene/butadiene copolymer latex (glass transition temperature: 15°; gel fraction. 75%), 6 weight parts of hydroxyethyl etherated starch (PG 295: Penford Co.) 0.8 weight parts of sodium chloride and water were then added to this pigment slurry so as to obtain a coating solution having a concentration of 60 wt %.

### 3. Manufacture of Coated Paper

### (1) Coating

The aforesaid coating solution was coated on both sides of the aforesaid base paper using a blade coater at a coating speed of 800 m/min so that the coating amount was 7 g/m² per side. After passing the paper through a scaff drier, it was dried using a cylinder drier so that the paper moisture amount was 5.5 wt %.

### (2) Calender Treatment

Next, the coated type electrophotographic transfer paper of the invention was obtained by performing soft nip calender treatment under the conditions of corresponding roll size 400 mm, metal roll temperature 160°; elastic roll Shaw hardness 85, paper transport speed 650 m/min, linear pressure 40 kg/cm and calender nip number of 2. The MD curl of the transfer paper after this calender treatment was 3 mm.

### Example 2

An electrophotographic transfer paper identical to that of Example 1 was obtained, except that the pigment composition of the coating solution was modified to 50 weight parts of kaolin (Capim DG: Imerys Co., volume distribution particle size 0.4-4.2 μm: 68.4%) and 50 weight parts of coarse ground calcium carbonate (FMT-75, Fimatech Co., proportion of particle size 0.4-4.2 μm based on volume: 69.5%).

### Example 3

An electrophotographic transfer paper identical to that of Example 1 was obtained, except that the pigment composition of the coating solution was modified to 65 weight parts of kaolin (Capim DG: Imerys Co., volume distribution particle size 0.4-4.2 μm: 68.4-4%) and 35 weight parts of coarse ground calcium carbonate (FMT-75: Fimatech Co., proportion of particle size 0.4-4.2 μm based on volume: 69.5%), and sodium chloride was not added.

### Comparative Example 1

An electrophotographic transfer paper identical to that of Example 1 was obtained, except that instead of kaolin (Capim DG), kaolin (proportion of particle size 0.4-4.2 μm based on volume: 60.2%) from the MIRASHEEN: Engelhard Co.) was used.

### Comparative Example 2

An electrophotographic transfer paper having a clark stiffness in the CD direction of 17 cm³/100 was obtained in an identical way to that of Example 1, except that the areal weight of the base paper was 39 g/m².

### Comparative Example 3

An electrophotographic transfer paper (designation: ST) which is the specified paper for use in a DocuTech 135 made by Fuji Xerox Co., was used.

The aforesaid evaluation was performed for the transfer papers described in the Examples and Comparative Examples. TABLE 1 shows the results.

TABLE 1

| | | | | | Comp. | Comp. | Comp. |
|---|---|---|---|---|---|---|---|
| | | Ex. 1 | Ex. 2 | Ex. 3 | Ex. 1 | Ex. 2 | Ex. 3 |
| areal weight | g/m² | 72 | 72 | 72 | 72 | 53 | 55 |
| Coating | g/m² | 14 | 14 | 14 | 14 | 14 | — |
| amount | | | | | | | |
| Clark | CD | 40 | 37 | 40 | 34 | 17 | 40 |
| stiffness | | | | | | | |
| Charge | seconds | 0.15 | 0.16 | 0.40 | 0.17 | 0.18 | 0.18 |
| decay | | | | | | | |
| time ½ | | | | | | | |
| Curl | MD | 3 | 3 | 3 | 3 | 3 | 2 |
| | CD | — | — | — | — | — | — |
| Continuous | Jams | 0 | 0 | 0 | 1 | 12 | 0 |
| travel •• | Double | 0 | 0 | 2 | 0 | 0 | 0 |
| properties | feeds | | | | | | |
| (10000 | | | | | | | |
| sheets) | | | | | | | |
| Color image | K | 1.81 | 1.79 | 1.80 | 1.73 | 1.73 | 1.57 |
| density | C | 0.71 | 0.70 | 0.71 | 0.62 | 0.70 | 0.66 |
| | M | 1.36 | 1.35 | 1.36 | 1.19 | 1.35 | 1.19 |
| | Y | 1.41 | 1.41 | 1.41 | 1.26 | 1.42 | 1.25 |
| Color image | K | 77 | 73 | 76 | 63 | 66 | 43 |
| gloss | C | 46 | 44 | 45 | 36 | 43 | 30 |
| | M | 56 | 53 | 56 | 43 | 49 | 43 |
| | Y | 51 | 49 | 51 | 33 | 43 | 32 |

In Examples 1-3, electrophotographic transfer papers having good continuous paper transport characteristics, and high color image density and gloss, were obtained. In Comparative Example 1, image density and image gloss were poor, in Comparative Example 2, image density and continuous transport characteristics were poor, and in Comparative Example 3, image density and image gloss were poor.

### Example 4

### 1. Manufacture of Base Paper

A pulp slurry was prepared by taking a pulp composition of 30 wt % NBKP, 40 wt % LBKP and 30 wt % SGP, adding 4 wt % of hydrated sodium aluminum silicate and 6 wt % of talc per paper weight as filler, adding 0.2 wt % of a rosin sizing agent as internal sizing agent, and 1.0 wt % of aluminum sulfate as fixing agent. Using the obtained pulp slurry, a base paper having an areal weight of 58 g/m² was then manufactured by a twin wire papermaking machine.

### 2. Preparation of Coating Solution

0.2 weight parts of sodium polyacrylate per 100 wt parts of pigment was added as dispersant to 70 weight parts of delaminated clay (Capim CC: Imerys°°Co., average particle size 4.9 μm based on volume) and 30 weight parts of coarse ground calcium carbonate (FMT-75: Fimatech Co., average particle size 0.95 μm based on volume) as pigment, water was added and the mixture dispersed by a Sellier mixer to obtain a pigment slurry having a solids concentration of 70 wt %. 10 weight parts of a non-thickening styrene/butadiene copolymer latex (glass transition temperature: 15* *; gel fraction: 75%), 6 weight parts of hydroxyethyl etherated starch (PG 295: Penford Co.), 0.4 weight parts of sodium chloride and water were then added to this pigment slurry so as to obtain a coating solution having a solids concentration of 60 wt %.

### 3. Manufacture of Electrophotographic Transfer Paper

### (1) Coating

The aforesaid coating solution was coated on both sides of the aforesaid base paper using a blade coater at a coating speed of 800 m/min so that the coating amount was 7 g/m² per side. After passing the paper through a scaff drier, it was dried using a cylinder drier so that the paper moisture amount was 5.5 wt %.

### (2) Calender Treatment

Next, the coated type electrophotographic transfer paper of the invention was obtained by performing soft nip calender treatment under the conditions of corresponding roll size 400 mm, metal roll temperature 160°; elastic roll Shaw hardness 85, paper transport speed 650 m/min, linear pressure 90 kg/cm and calender nip number of 2. The MD curl of the transfer paper after this calender treatment was 3 mm.

### Example 5

An electrophotographic transfer paper was obtained in the same way as that of Example 4, except that the pigment composition of the coating solution was modified to 50 weight parts of delaminated clay (Capim CC: Imerys Co., average particle size 4.9 μm based on volume) and 50 weight parts of coarse ground calcium carbonate (FMT-75: Fimatech Co., average particle size 0.95 μm based on volume).

### Example 6

An electrophotographic transfer paper was obtained in the same way as that of Example 4, except that the pigment composition of the coating solution was modified to 65 weight parts of delaminated clay (Capim CC: Imerys Co., particle size 4.9 μm based on volume) and 35 weight parts of coarse ground calcium carbonate (FMT-75: Fimatech Co., average particle size 0.95 μm based on volume), and sodium chloride was not added.

### Comparative Example 4

An electrophotographic transfer paper was obtained in the same way as that of Example 4, except that 25 weight parts of delaminated clay (Capim CC: Imerys Co., volume distribution particle size 4.9 μm) and 75 weight parts of coarse ground calcium carbonate (FMT-75: Faimatec, average particle size 0.95 μm based on volume) was used.

### Comparative Example 5

An electrophotographic transfer paper was obtained in the same way as in Example 4 was obtained, except that instead of large particle delaminated clay (Capim CC: Imerys Co., particle size 4.9 μm based on volume), delaminated clay (Nu-Clay: Engelhard Co., average particle size 2.4 μm based on volume) was used.

### Comparative Example 6

An electrophotographic transfer paper was obtained in the same way as that of Example 4, except that the calender treatment of the coated paper was performed at 200° ° and a calender line pressure of 300 kg/cm.

The same evaluation as that of Example 1 was performed for the transfer papers described in Examples 4-6 and Comparative Examples 4-6. TABLE 2 shows the results.

TABLE 2

| | | | | | Comp. | Comp. | Comp. |
|---|---|---|---|---|---|---|---|
| | | Ex. 4 | Ex. 5 | Ex. 6 | Ex. 4 | Ex. 5 | Ex. 6 |
| areal weight | g/m² | 72 | 72 | 72 | 72 | 53 | 55 |
| Coating | g/m² | 14 | 14 | 14 | 14 | 14 | — |
| amount | | | | | | | |
| Clark | CD | 40 | 37 | 40 | 34 | 33 | 18 |
| stiffness | | | | | | | |
| Charge | seconds | 0.18 | 0.20 | 0.42 | 0.20 | 0.19 | 0.18 |
| decay | | | | | | | |
| time ½ | | | | | | | |
| Curl | MD | 3 | 3 | 3 | 4 | 3 | 2 |
| | CD | — | — | — | — | — | — |
| Continuous | Jams | 0 | 0 | 0 | 1 | 1 | 8 |
| travel | Double | 0 | 0 | 2 | 0 | 0 | 0 |
| properties | feeds | | | | | | |
| (10000 | | | | | | | |
| sheets) | | | | | | | |
| Color image | K | 1.90 | 1.88 | 1.90 | 1.84 | 1.57 | 1.95 |
| density | C | 0.70 | 0.69 | 0.70 | 0.61 | 0.61 | 0.71 |
| | M | 1.48 | 1.47 | 1.48 | 1.40 | 1.36 | 1.53 |
| | Y | 1.42 | 1.4 | 1.42 | 1.27 | 1.21 | 1.46 |
| Color image | K | 73 | 70 | 73 | 55 | 56 | 78 |
| gloss | C | 35 | 35 | 35 | 31 | 29 | 41 |
| | M | 51 | 50 | 51 | 46 | 47 | 58 |
| | Y | 49 | 48 | 49 | 35 | 36 | 51 |

As is clear from Table 2, in Examples 4-6, color image density and color image gloss were high, the image was sharp and paper transport properties were good, confirming that the papers could be used for business documents and official documents. On the other hand, in the case of Comparative Example 4, color image gloss was poor, while in the case of Comparative Example 5, color image density and image gloss were poor, and in the case of Comparative Example 6, clark stiffness was low and continuous transport were poor.

By comparing with the results of Examples 1-3 in TABLE 1, it was seen that if an amorphous silicate was used as filler, black (K) and magenta (M) image densities were particularly enhanced.

### 1. Preparation of Precipitated Calcium Carbonate/Silica Complexes A and B

### (1) Preparation of Precipitated Calcium Carbonate/Silica Complex A

11 weight parts of a commercial Rosetta precipitated calcium carbonate (commercial name: Albacar 5970, SMI Co.) was dispersed in water in a reaction vessel. Next, 62 weight parts of a sodium silicate solution containing 18.0 wt % of SiO₂ and 6.1 wt % of Na₂O was added, and water was added to bring the total volume to 220 weight parts. This mixed slurry was then heated while thoroughly staring in an agitator, and 10% sulfuric acid solution was added from a metering pump to the slurry at 8H° °. In this case, the sulfuric acid addition port was arranged directly beneath the agitator stirring blades so that the sulfuric acid was thoroughly stirred.

In this case, the sulfuric acid was added at a constant rate under such conditions so that it was thoroughly dispersed, at a constant temperature, so that the final pH after sulfuric acid addition was 8.0 and the total sulfuric acid addition time was 240 minutes. Coarse particles were separated from the slurry using a 100 mesh sieve. Next, it was filtered by a belt filter, re-dispersed to approximately 10%, and a precipitated calcium carbonate/silica complex A was thus obtained.

Part of the obtained a precipitated calcium carbonate/silica complex A was re-dispersed to approximately 10% in ethanol, re-filtered, and dried at 105° ° using a drier so as to obtain a powder sample for measuring oil absorption amount and BET specific surface. When the obtained sample was measured, the average particle size was 3.4 μm, and the oil absorption amount was 159 ml/100 g. It may be noted that the average particle size of commercial Rosetta precipitated calcium carbonate used as core was 3.0 μm, and its oil absorption amount was 119 ml/100 g.

### (2) Preparation of Precipitated Calcium Carbonate/Silica Complex B

The precipitated calcium carbonate/silica complex B was obtained in an identical way to that of Manufacturing Example 1, except that 25 weight parts of commercial Rosetta precipitated calcium carbonate (commercial name: Albacar 5970, SMI Co.) was used. When physical measurements were performed in the same way as in Manufacturing Example 1 for the obtained complex, the average particle size was 4 μm and the oil absorption amount was 134 ml/100 g.

### Example 7

### 1. Manufacture of Base Paper

A paper was made using an on-top twinwire papermaking machine, using a slurry comprising 30 wt parts NBKP, 40 wt parts LIKP and 30 wt parts SGP as papermaking starting material pulp, with the addition of 1.0 wt % and 0.8 wt % of neutral rosin sizing agent (NT-87: Arakawa Chemical Co.) and cationic starch (cATO304: Japan NSC Co.) relative to pulp respectively, 0.02 wt % of cationic polyacrylamide relative to pulp and 0.01 wt % of anionic polyacrylamide relative to pulp as yield enhancing agents, and further containing precipitated calcium carbonate/silica complex A to a paper fill rate of 5 wt % and talc to a paper fill rate of 5 wt %. Next, a size press solution containing 6 wt % of starch (Japan Food Processing Co.: TC Starch) and 0.5 wt % of a sizing agent (Arakawa Chemical Co.: PM 1308), was coated on both sides to 1.0 g/m² so as to obtain a base paper having an areal weight after drying of 56 g/m².

### 2. Preparation of Coating Solution

0.2 weight parts of sodium polyacrylate per 100 wt parts of pigment was added as dispersant to 70 weight parts of kaolin (Capim DG: Imerys Co., volume distribution particle size 0.4-4.2 μm: 68.4%) and 30 weight parts of coarse ground calcium carbonate (FMT-75: Fimatech Co., average particle size 0.95 μm based on volume) as pigment, and the mixture was dispersed by a Sellier mixer to obtain a pigment slurry having a solids concentration of 70 wt %. 10 weight parts of a non-thickening styrene/butadiene copolymer latex (glass transition temperature: 15°; gel fraction: 75%), 6 weight parts of hydroxyethyl etherated starch (PG 295: Penford Co.), 0.8 weight parts of sodium chloride and water were then added to this pigment slurry so as to obtain a coating solution having a concentration of 60 wt %.

### 3. Manufacture of Electrophotographic Transfer Paper

### (1) Coating

The aforesaid coating solution was coated on both sides of the aforesaid base paper using a blade coater at a coating speed of 800 m/min so that the coating amount was 7 g/m² per side. After passing the paper through a scaff drier, it was dried using a cylinder drier so that the paper moisture amount was 5.5 wt %.

### (2) Calender Treatment

Next, the coated type electrophotographic transfer paper of the invention was obtained by performing soft nip calender treatment under the conditions of corresponding roll size 400 mm, metal roll temperature 160°; elastic roll Shaw hardness 85, paper transport speed 650 m/min, linear pressure 40 kg/cm and calender nip number of 2. The MD curl of the transfer paper after this calender treatment was 3 mm.

### Example 8

An electrophotographic transfer paper identical to that of Example 7 was obtained, except that the pigment composition of the coating solution was modified to 50 weight parts of kaolin (Capim DG: Imerys Co., volume distribution particle size 0.4-4.2 μm: 68.4%) and 50 weight parts of coarse ground calcium carbonate (FMT-75: Fimatech Co., proportion of particle size 0.4-4.2 μm based on volume: 69.5%).

### Example 9

An electrophotographic transfer paper identical to that of Example 7 was obtained, except that the pigment composition of the coating solution was modified to 50 weight parts of delaminated clay (Capim CC: Imerys Co., average particle size 4.9 μm) and 50 weight parts of coarse ground calcium carbonate (FMT-75: Fimatech Co., average particle size 0.95 μm based on volume), and the calender line pressure was modified to 90 kg/cm.

### Example 10

An electrophotographic transfer paper identical to that of Example 9 was obtained, except that the pigment composition of the coating solution was modified to 65 weight parts of delaminated clay (Capim CC: Imerys Co., average particle size 4.9 μm) and 35 weight parts of coarse ground calcium carbonate (FMT-75: Fimatech Co., average particle size 0.95 μm based on volume).

### Comparative Example 7

An electrophotographic transfer paper was obtained in the same way as that of Example 7, except that instead of the kaolin (Capim DG) used in Example 7, kaolin (MIRASHEEN: Produced by the Engelhard Co., proportion of particle size 0.4-4.2 μm based on volume is 60.2%) was used.

### Comparative Example 8

An electrophotographic transfer paper was obtained in the same way as in Example 9, except that instead of the delaminated clay (Capim CC: Imerys Co., volume distribution particle size 4.9 μm) used in Example 9, delaminated clay (Nu-Clay: Produced by the Engelhard Co., average particle size is 2.4 μm based on volume) was used.

The same evaluation as that of Example 1 was performed for the transfer papers described in Examples 7-10 and Comparative Examples 7, 8. TABLE 3 shows the results.

TABLE 3

| | | | | | | Comp. | Comp. |
|---|---|---|---|---|---|---|---|
| | | Ex. 7 | Ex. 8 | Ex. 9 | Ex. 10 | Ex. 7 | Ex. 8 |
| areal weight | g/m² | 70 | 70 | 70 | 70 | 70 | 70 |
| Light | % | 50/50 | 70/30 | 50/50 | 50/50 | 50/50 | 50/50 |
| calcium/ | | | | | | | |
| silica | | | | | | | |
| ratio | | | | | | | |
| Coating | g/m² | 14 | 14 | 14 | 14 | 14 | 14 |
| amount | | | | | | | |
| Clark | CD | 40 | 37 | 39 | 36 | 35 | 33 |
| stiffness | | | | | | | |
| Charge | seconds | 0.16 | 0.19 | 0.18 | 0.2 | 0.20 | 0.18 |
| decay | | | | | | | |
| time ½ | | | | | | | |
| Curl | MD | 3 | 3 | 3 | 3 | 3 | 2 |
| | CD | — | — | — | — | — | — |
| Continuous | Jams | 0 | 0 | 0 | 0 | 0 | 0 |
| travel | Double | 0 | 0 | 0 | 0 | 0 | 0 |
| properties | feeds | | | | | | |
| (10000 | | | | | | | |
| sheets) | | | | | | | |
| Color image | K | 1.80 | 1.79 | 1.89 | 1.87 | 1.74 | 1.58 |
| density | C | 0.72 | 0.71 | 0.71 | 0.69 | 0.62 | 0.61 |
| | M | 1.35 | 1.34 | 1.45 | 1.45 | 1.18 | 1.36 |
| | Y | 1.41 | 1.42 | 1.42 | 1.41 | 1.27 | 1.21 |
| Color image | K | 79 | 78 | 74 | 71 | 64 | 56 |
| gloss | C | 48 | 46 | 36 | 36 | 38 | 30 |
| | M | 57 | 56 | 52 | 51 | 45 | 48 |
| | Y | 53 | 52 | 50 | 50 | 36 | 38 |

*Charge decay time ½: time required for the maximum value of the charge when a voltage of −10 kv is applied, to be attenuated to ½

As can be seen from TABLE 3, in the case of the electrophotographic transfer papers of Examples 7-10, color print density and color print gloss are both high, the image is sharp and paper transport properties are good, confirming that the paper is suitable for use in business documents and official documents. On the other hand, in the case of Comparative Examples 7 and 8, color image density and image gloss were poor.

In particular, comparing Examples 9 and 10 with the results of Examples 1-3 of TABLE 1, the image densities of black (K) and magenta (M) were enhanced, showing that the use of precipitated calcium carbonate/silica complex as filler was effective.

### INDUSTRIAL APPLICATION OF THE INVENTION

The electrophotographic transfer paper of the invention has the continuous paper transport properties required in electrophotographic sheet high speed copy machines and printers together with excellent color printing performance, and can be used for official documents and the like, so it has a high industrial usefulness.

1. An electrophotographic transfer paper wherein a coating layer having a pigment and a binder coated on at least one side of a base paper comprising a pulp and a filler, wherein 30 wt % or more of said pigment is kaolin having a particle size distribution containing 65% or more particles in a range of 0.4-4.2 μm based on volume and/or delaminated clay having an average particle size of 3.5-20 μm, and the clark stiffness in the CD direction of said electrophotographic transfer paper is 20 cm3/100 or more.

2. The electrophotographic transfer paper according to claim 1, wherein said filler contains an amorphous silicate.

3. The electrophotographic transfer paper according to claim 1, wherein said filler contains precipitated calcium carbonate/silica complex wherein the surface of precipitated calcium carbonate particles are coated with silica.

4. The electrophotographic transfer paper according to claim 3, wherein the solids weight ratio of precipitated calcium carbonate and silica (precipitated calcium carbonate/silica) in said precipitated calcium carbonate silica complex, is 30/70-70/30.

5. The electrophotographic transfer paper according to claim 1, wherein a time required for the maximum value of the electrostatic charge to be decreased to one half when a voltage of −10 kv is applied to the transfer paper surface at 23; 50% RH, is 0.25 seconds or less.

6. The electrophotographic transfer paper according to claim 1, wherein 10-60 wt % of the pulp in said base paper is a mechanical pulp.

7. The electrophotographic transfer paper according to claim 1, wherein the coating amount of said coating layer is 2-15 g/m2 per side.
